(19) United States
(12) Patent Application Publication
(10) Pub. No.: US 2003/0218005 A1
(43) Pub. Date: Nov. 27, 2003

(54) Anti-binding electrical heating device

(76) Inventor: Jeffrey V. Wheeler, Battle Creek, MI (US)

Correspondence Address: Mr. Edward J. Timmer, Walnut Woods Centre, 5955 W. Main Street, Kalamazoo, MI, 49009, US

(21) Appl. No.: 10/281,468

(22) Filed: Oct. 24, 2002

Related U.S. Application Data
(60) Provisional application No. 60/382,992, filed on May 23, 2002.

(51) Int. Cl. H05B 3/34

(52) U.S. Cl. 219/534; 219/544

(57) ABSTRACT

An electrical heating device includes a metallic coating to reduce binding or seizing of the heating device in a passage of a metal member such that the heating device can be readily removed from the passage after prolonged use. The metallic coating can include a metallic matrix having a non-sticking, non-metallic constituent distributed in the matrix. The coated heating element resists binding in the metal member.

This application claims the benefits of provisional application Serial No. 60/382,992 filed May 23, 2002.

### FIELD OF THE INVENTION

The present invention relates to an electrical heating device having a coating thereon that reduces binding or seizing of the heating device in a metallic member receiving the heating device.

### BACKGROUND OF THE INVENTION

Electrical heating devices of various types are used to heat molds, dies, and the like of processing machines of various types as well as used in various other heating applications. For example, electrical heating devices are used in the plastics molding industry to heat certain sections of a metallic (e.g. steel, stainless steel, etc.) mold in which plastic material is molded. For example, an electrical heating device can be disposed in a passage located about an injection passage through which molten plastic material is injected into a mold cavity. Moreover, certain regions of the mold proximate the mold cavity may require localized heating by one or more heating devices to improve the plastic molding operation. Such heating devices can include elongated cartridge heating devices that are inserted in close tolerance fit in elongated passages in the metallic mold as well as coil heating devices that are inserted in the mold about a passage or mold cavity. After a prolonged time residing in a passage in the metallic mold, a conventional metal-sheathed electrical heating device can become difficult to remove from the passage in which it resides as a result of binding or seizing of the heating device in the passage wherein such binding or seizing is attributable to galling between a protective metal sheath of the heating device and the surface of the metallic mold that forms the passage as well as to oxidation, corrosion and/or galvanic reactions involving the metal sheath. Such binding or seizing of the heating device in the passage can prevent removal and replacement of a failed heating device from the metallic mold of the processing machine. Such binding or seizing of the heating device in the metallic mold oftentimes requires removal of the metallic mold from the processing machine and special operations to then remove the failed heating device therefrom. Such special operations may require costly reaming or repairing of the passage after the heating device is removed.

### SUMMARY OF THE INVENTION

The present invention provides an electrical heating device that includes a metallic coating to resist binding or seizing between the heating device and a heated metallic member over time such that the heating device and metal member can be readily separated after prolonged time in use. In an embodiment, the heating device with the metallic coating is disposed in a passage in the metallic member and is readily removed from the passage after prolonged use heating the metallic member. The metallic coating preferably includes a metallic matrix having a non-sticking, non-metallic constituent distributed in the matrix. The coated heating element unexpectedly resists binding or seizing with the metallic member even when the temperature of the metallic member is above the melting range of the non-metallic constituent in practice of a particular embodiment of the invention.

In an illustrative embodiment of the present invention, the coating comprises a nickel based or other metallic based matrix having non-sticking polytetrafluoroethylene (PTFE) constituent regions distributed in the matrix. The coating remains bonded to the heating device without powdering or flaking over time and is effective to reduce binding or seizing of the heating device in a passage of a heated metallic member attributable to galling and/or oxidation, corrosion, galvanic and/or metallurgical reactions of the electrical heating device in the passage in the metallic member even when temperatures of the metal member exceed the melting range of PTFE such that the heating device can be readily manually pulled out of the passage for replacement or repair after prolonged times in use. The above advantages of the present invention will become more readily apparent from the following description taken with the following drawings.

### DESCRIPTION OF THE DRAWINGS

FIG. 1 is a perspective view, partially broken away, of a metallic member showing a cartridge electrical heating device residing in a passage thereof adjacent a surface of the metallic member so that the heating device can heat the metallic member.

FIG. 2 is a longitudinal sectional view of a cartridge electrical heating device having an anti-binding or seizing coating on a metallic housing of the cartridge heating device pursuant to an embodiment of the invention.

FIG. 3A is a photomicrograph through the thickness of an illustrative anti-binding or seizing coating on the metallic housing. FIG. 3B is a sectional view of another illustrative coating on the metallic housing.

FIG. 4 is a perspective view showing a coil electrical heating device about and adjacent a surface of a mold injection tool or nozzle, the coil heating device having an anti-binding or seizing coating thereon.

### DETAILED DESCRIPTION OF THE INVENTION

In an illustrative embodiment, the present invention provides an electrical heating device that resists binding or seizing during use for prolonged time in a passage adjacent a surface of a heated metallic member such that the heating device can be readily removed from the passage after prolonged time in use, for example, by simply pulling the heating device out of the passage. The heating device pursuant to the invention resists binding or seizing attributable, but not limited, to galling between a protective metal sheath of the heating device and a passage receiving the heating device and/or to oxidation, corrosion, galvanic and/or metallurgical reactions involving the metal sheath of the heating device.

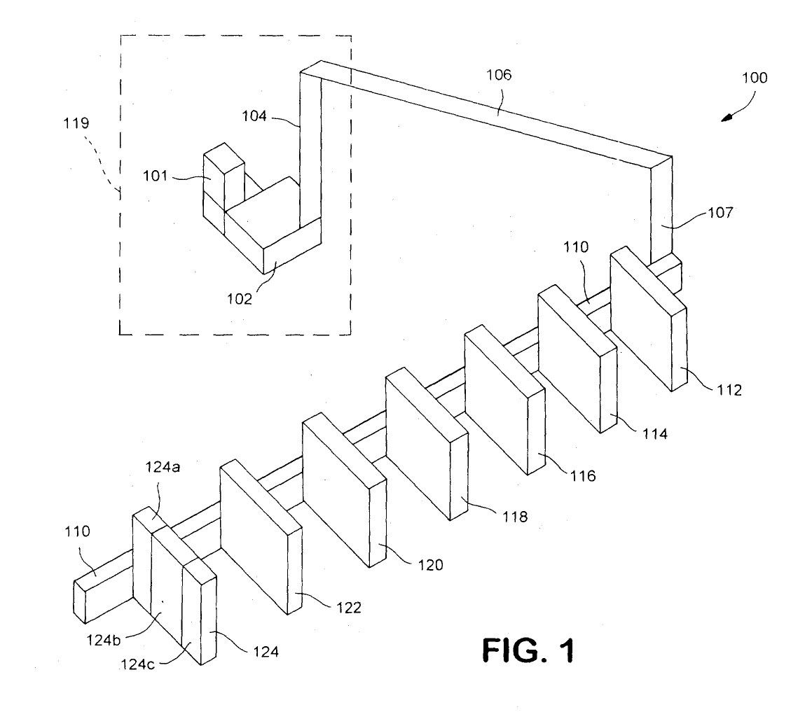

Referring to FIG. 1, a coated electrical cartridge heating device 10 having an illustrative anti-binding or seizing coating 10a in accordance with an illustrative embodiment of the invention is shown disposed in a passage 20a of a metallic member 20, which may comprise, but is not limited to, a metallic mold, die, steel plastic injection mold, packaging jaw, rubber injection mold, heating plate, melt delivery goose neck of a die casting machine, and any other heated metallic member that receives or cooperates with the heating device. The heating device 10 functions as a heat source when energized to provide thermal energy to heat the metallic member 20. To this end, for a cylindrical heating device 10, the outer diameter of the heating device 10 is received in tight fit in the passage 20a of the metal member 20. For example, a clearance of only 0.0008 inch may be provided between the outer diameter of the heating device 10 and the adjacent surface 20b forming the passage 20a in metallic member 20.

Although the heating device 10 is described and shown in FIG. 1 for purposes of illustration and not limitation as an axially elongated, cylindrical heating device, it can be any shape or configuration as required by a particular service application. For example, the heating device can comprise a coil heating device 10′ having anti-binding outer coating 10a′ on a metallic coil housing 10b′ in which an electrical heating element (not shown) is disposed. The coil heating device is disposed in tight fit on and adjacent an exterior surface of a cylindrical metallic mold injection tool or nozzle 20′ so as to heat the tool or nozzle 20′. The mold injection tool or nozzle 20′ has a plastic melt flow passage 20a′ therein that delivers molten plastic to mold 21′. The coil electrical heating device 10′ including coating 10a′ resists binding or seizing between the heating device 10′ and the heated tool or nozzle 20′ over time such that the heating device and tool or nozzle can be readily separated after prolonged time in use. Other shapes or configurations of the coated heating device are envisioned within the present invention.

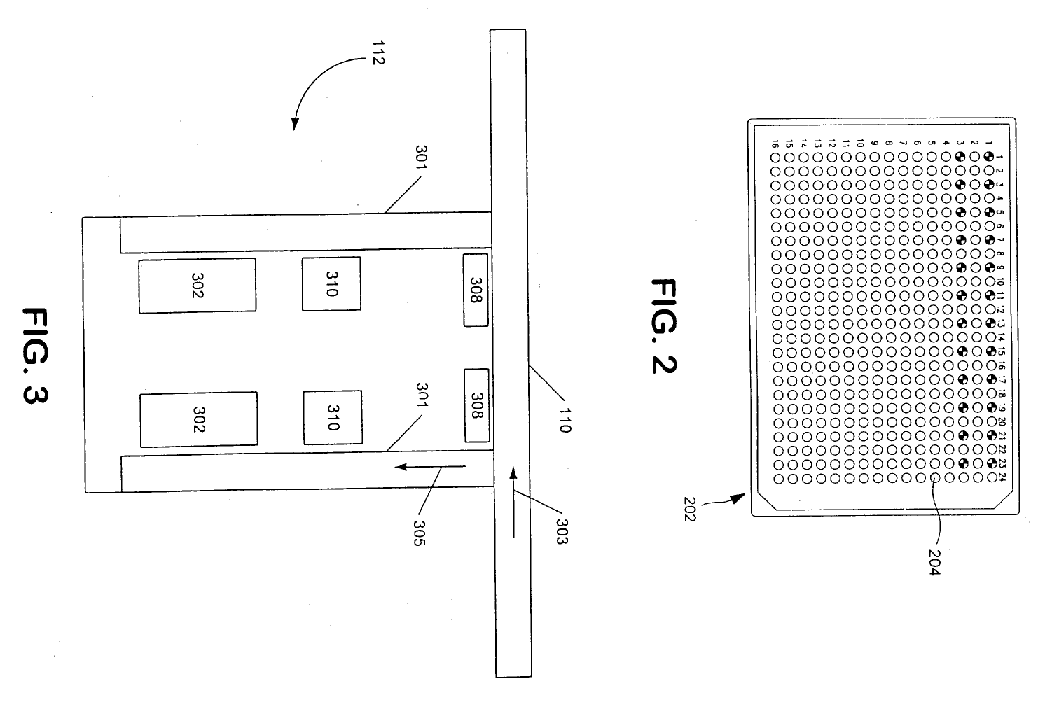

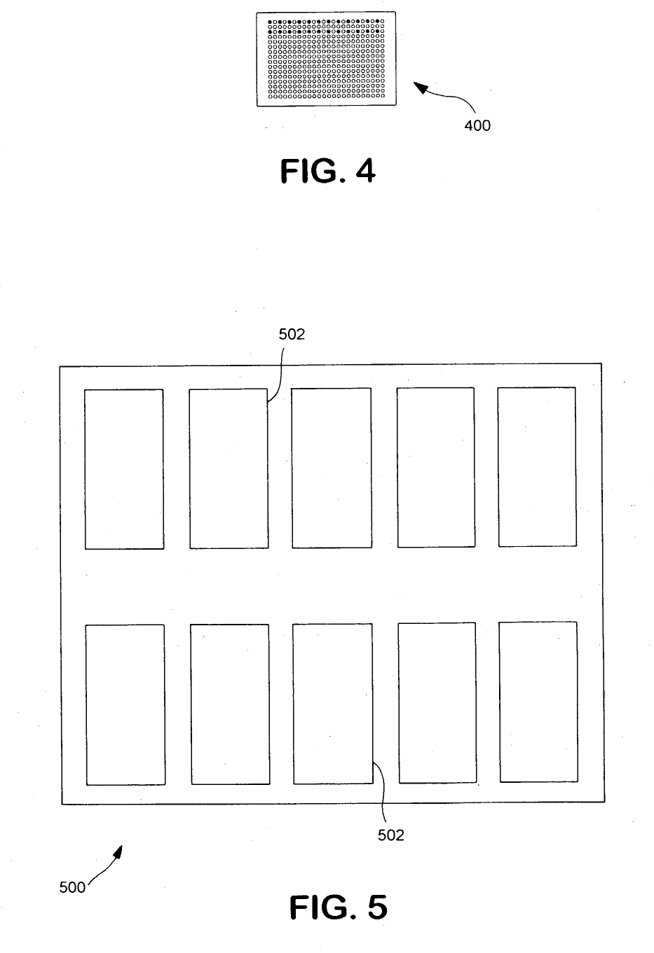

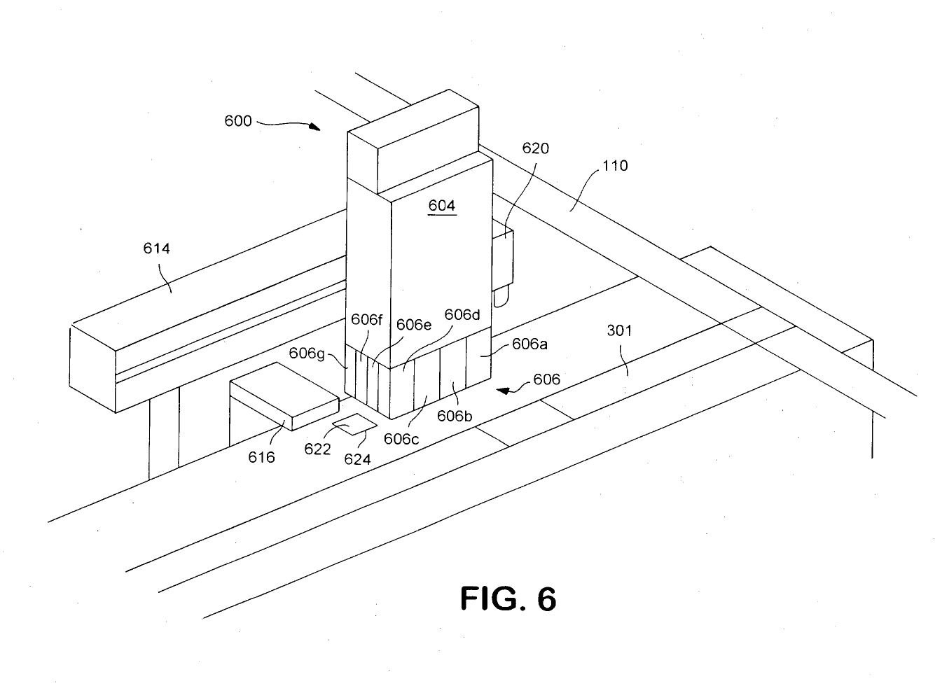

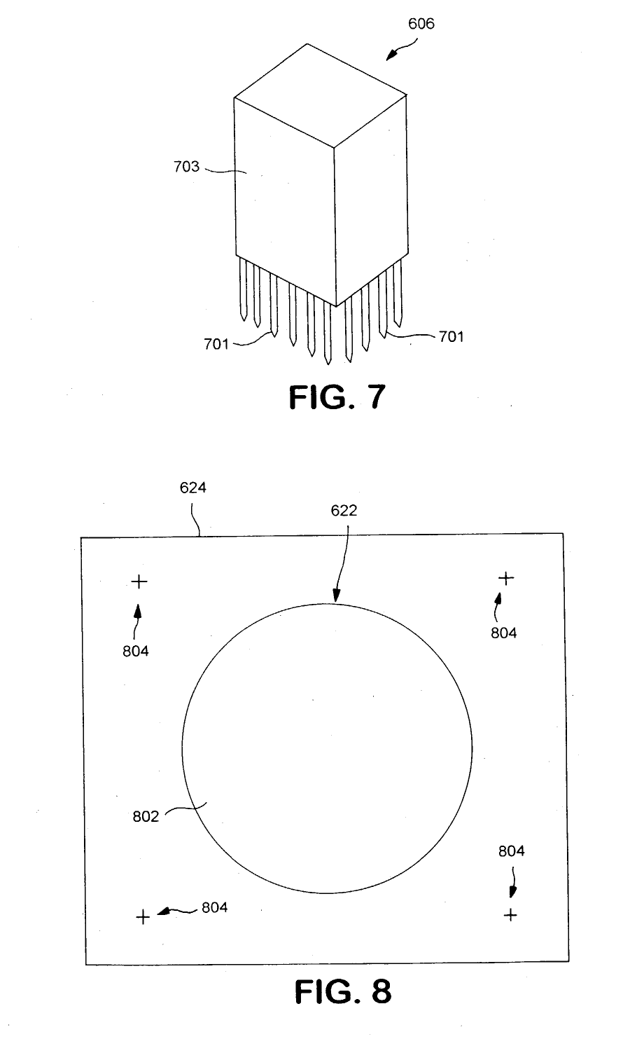

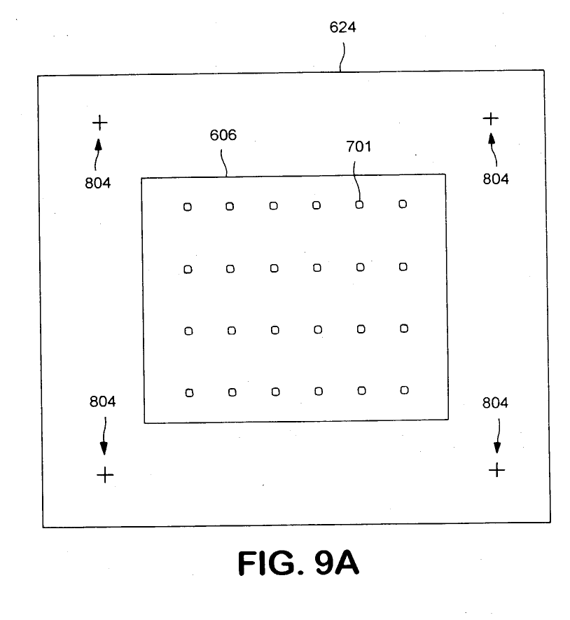

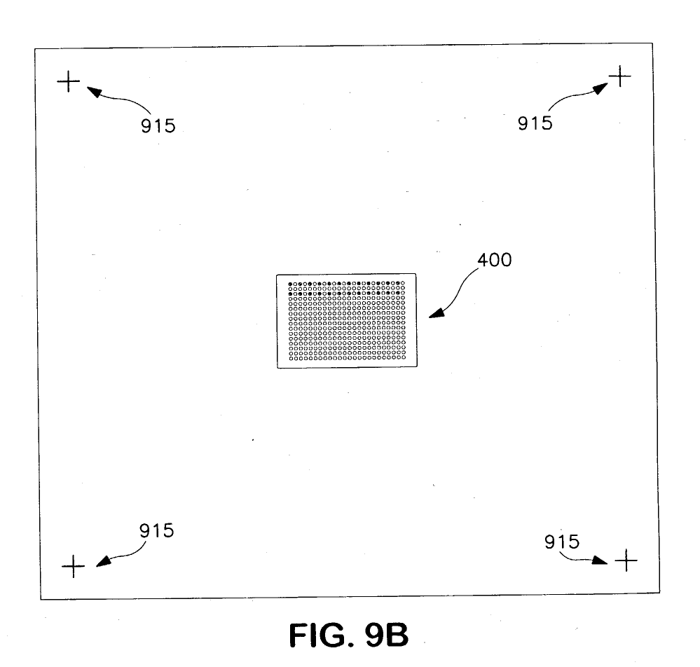

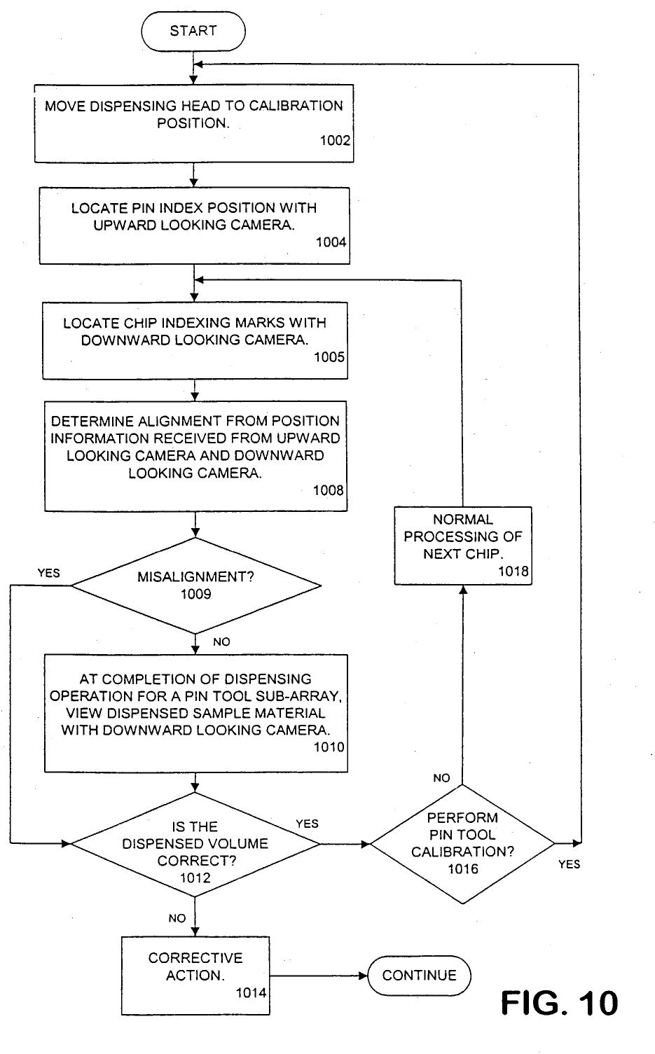

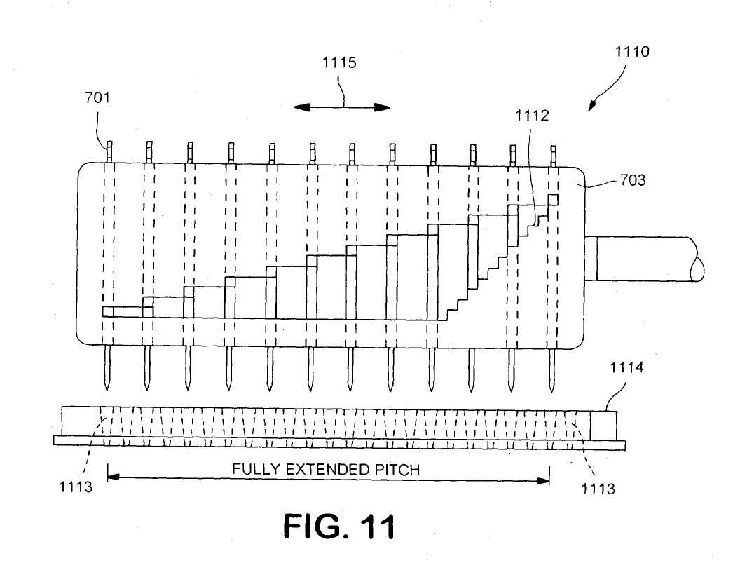

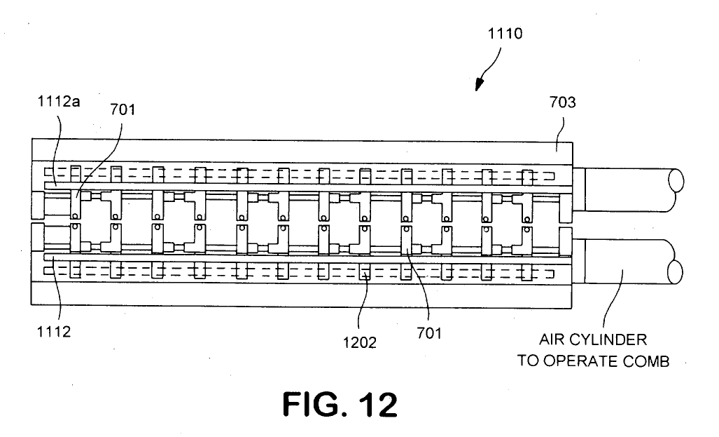

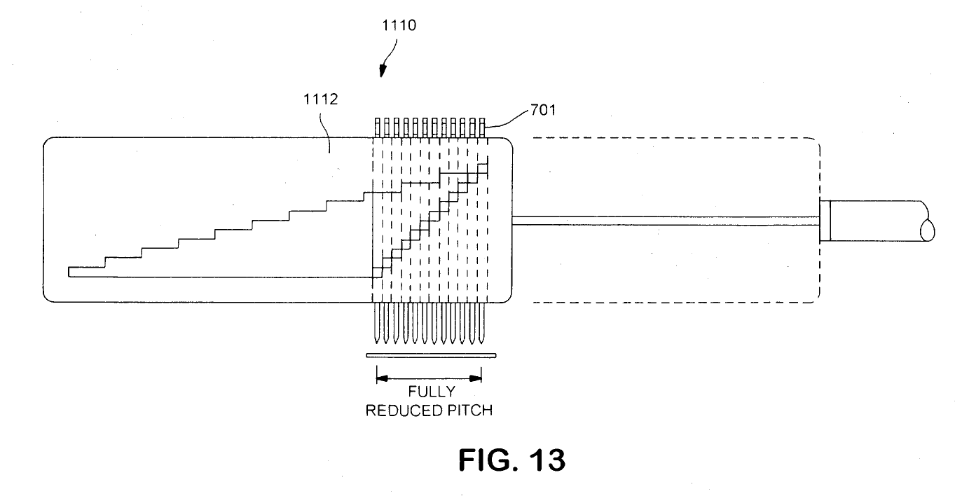

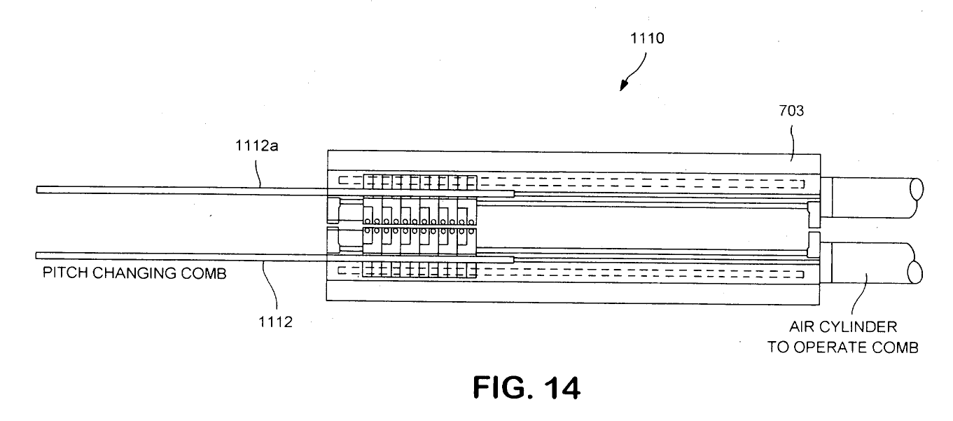

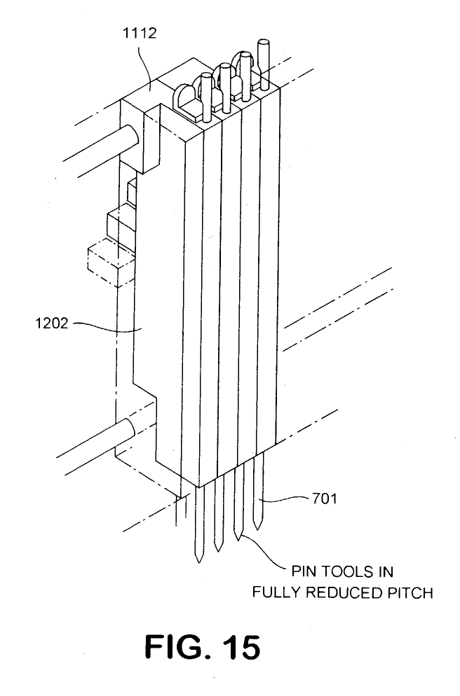

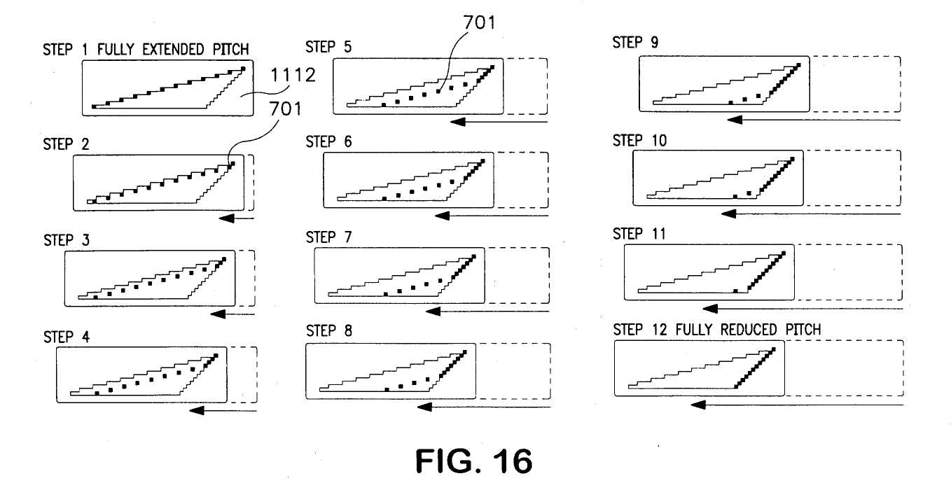

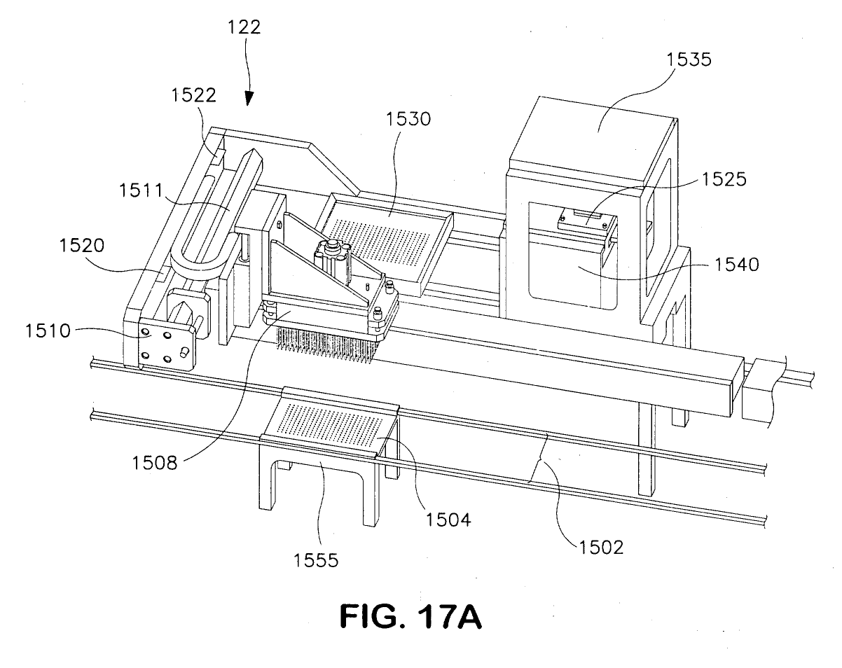

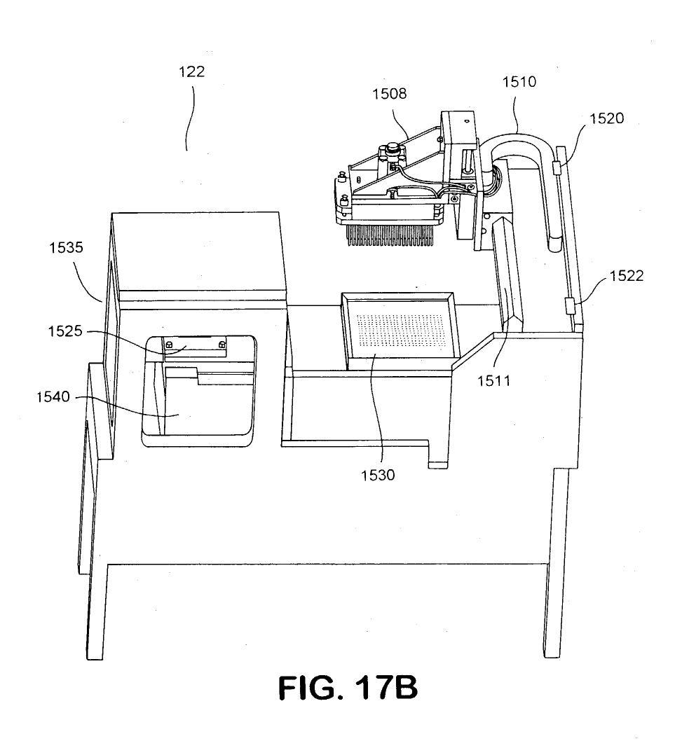

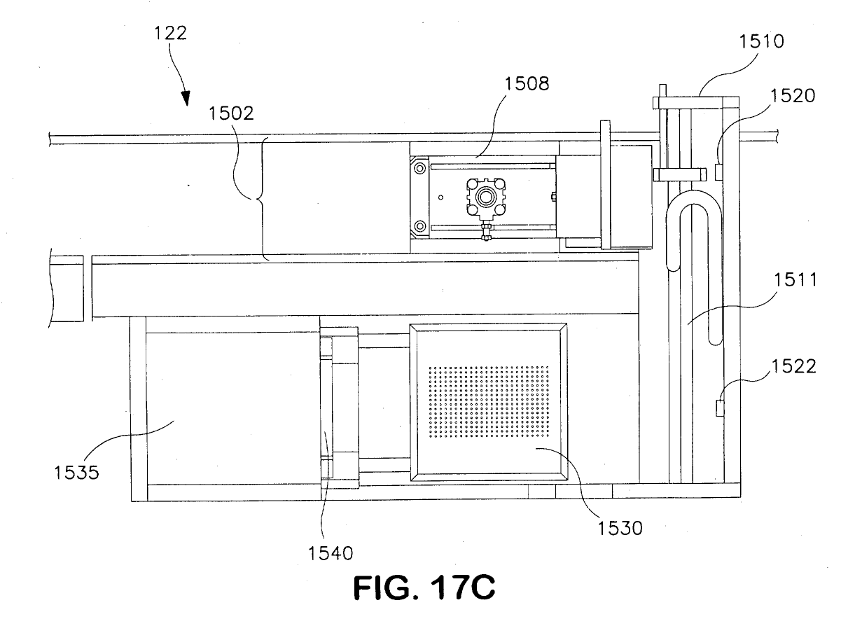

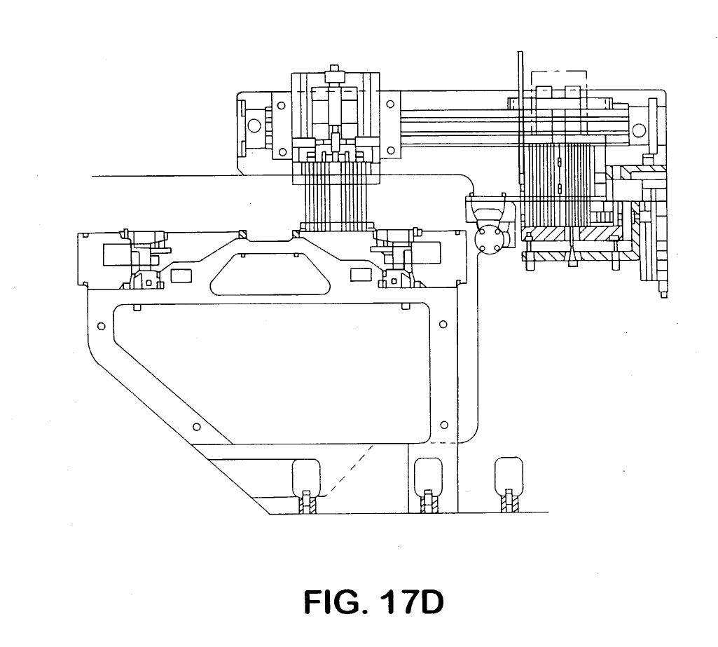

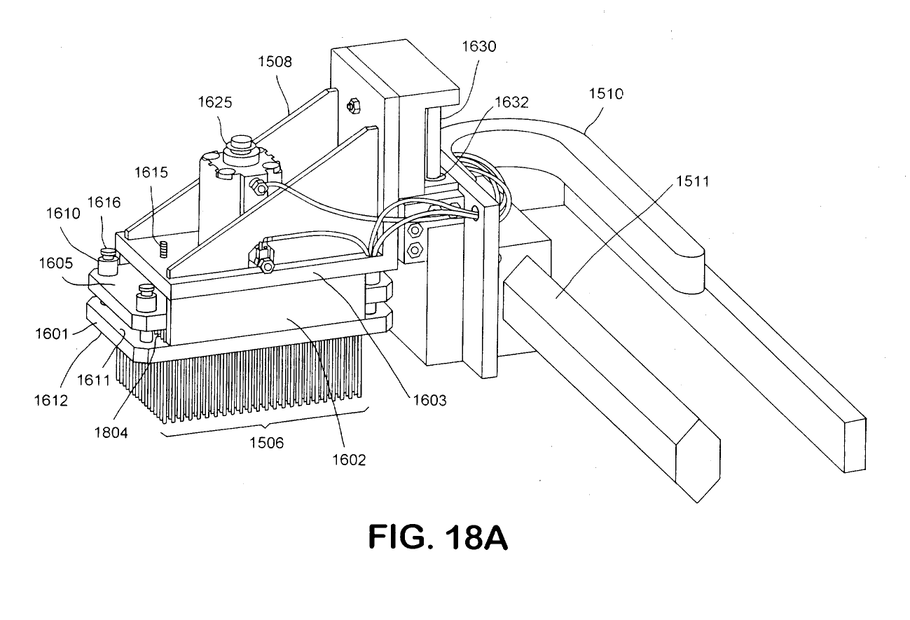

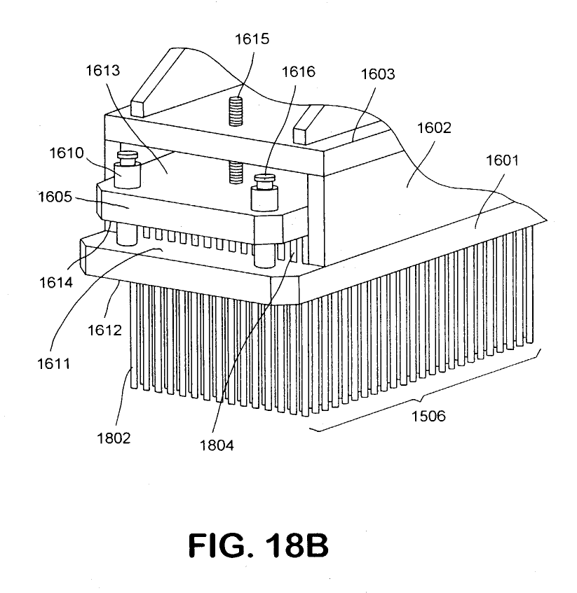

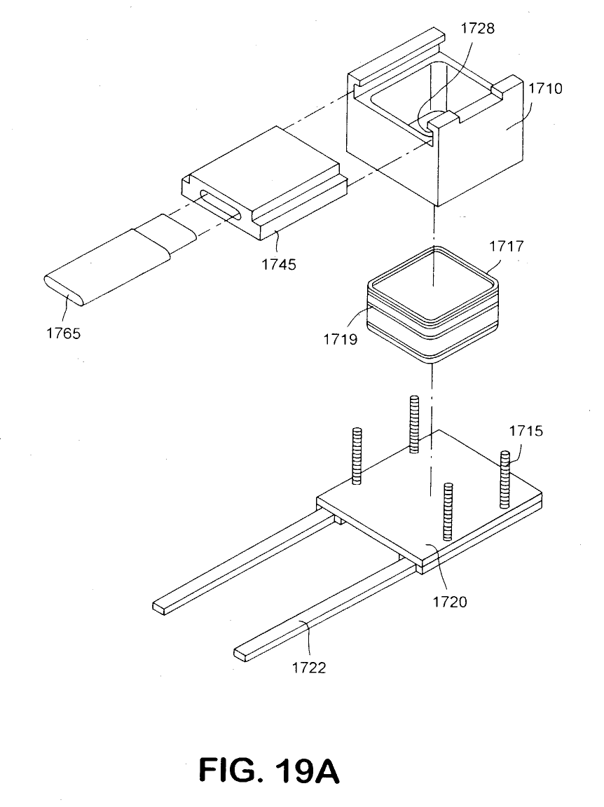

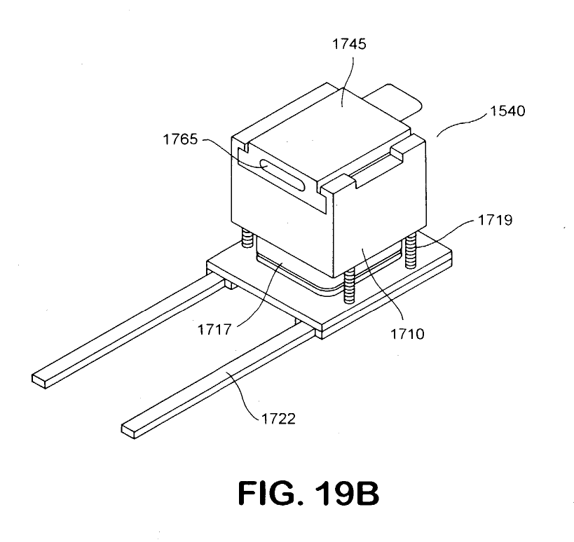

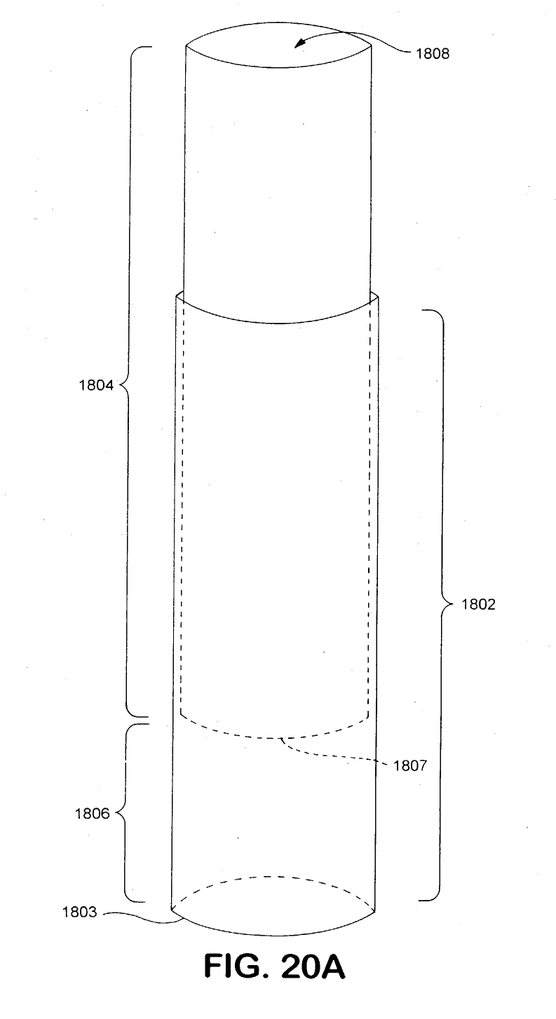

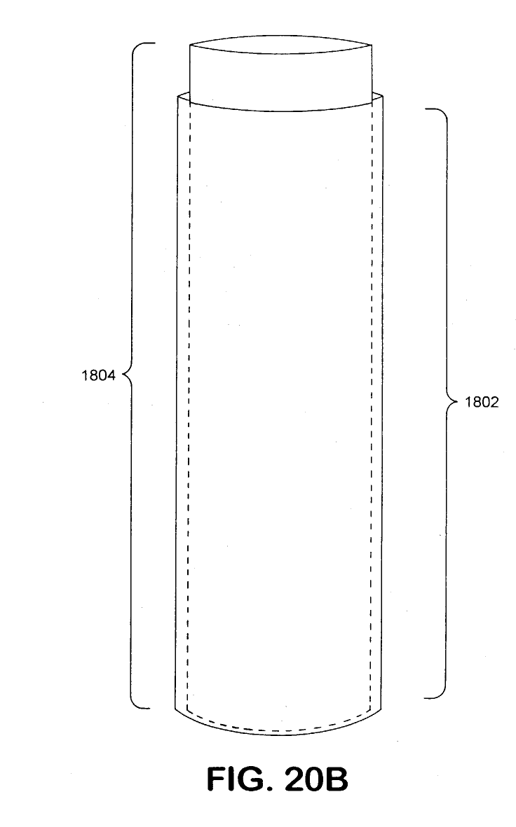

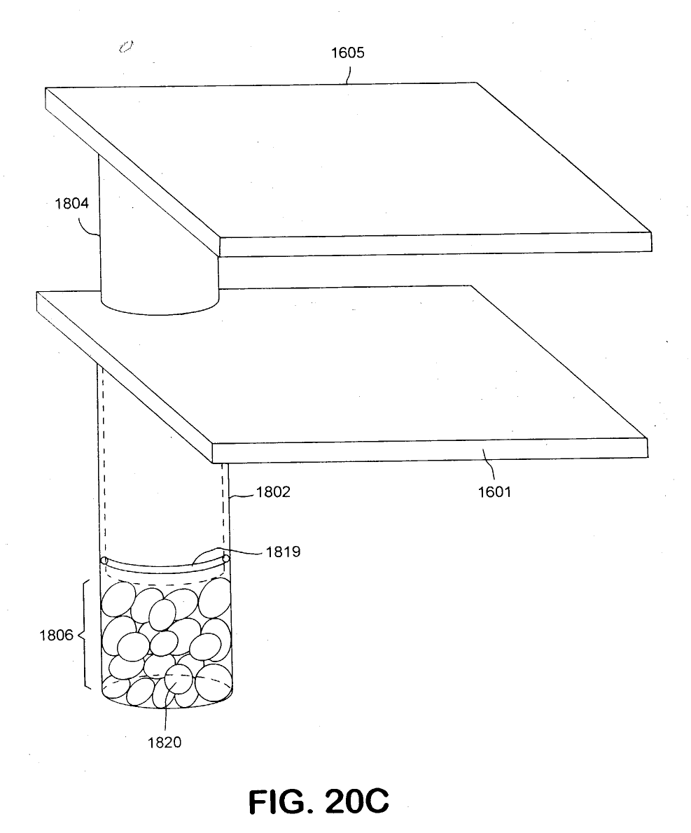

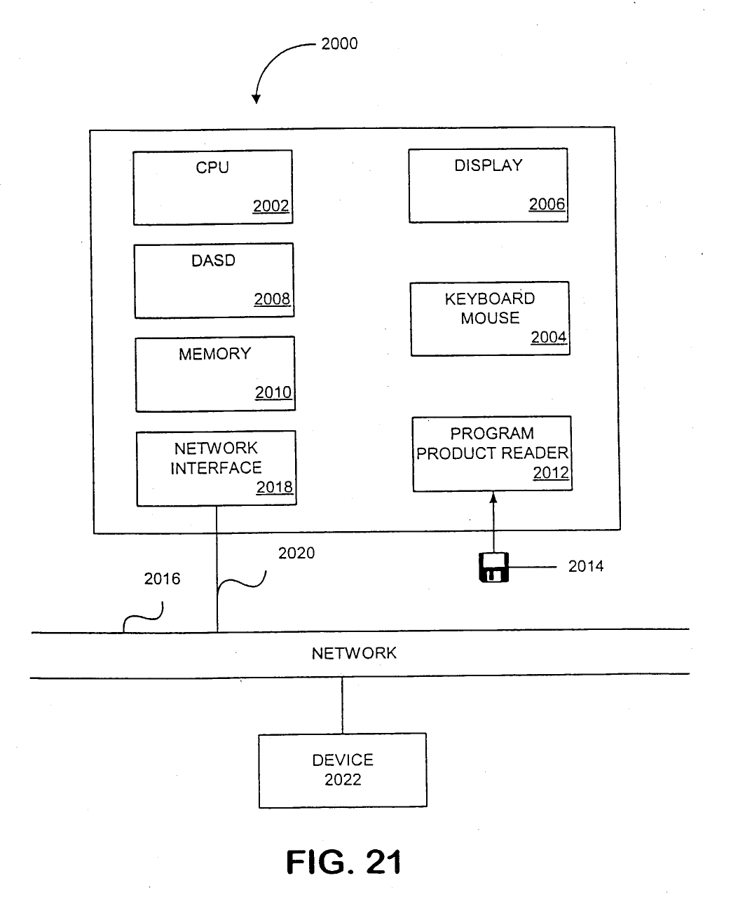

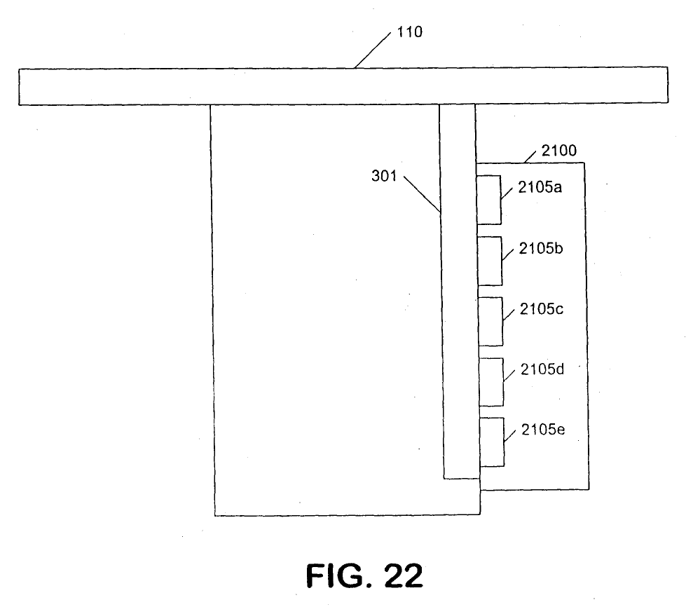

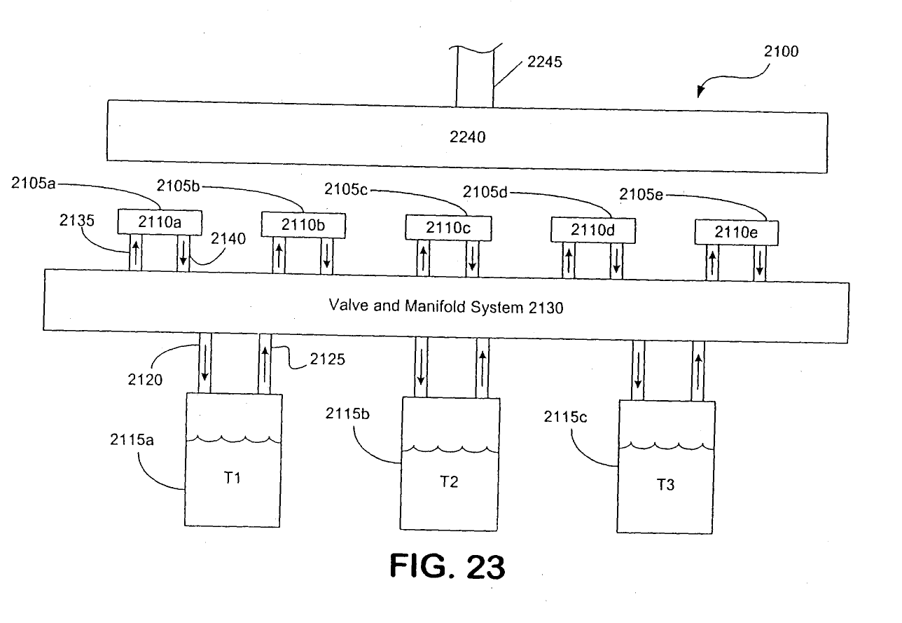

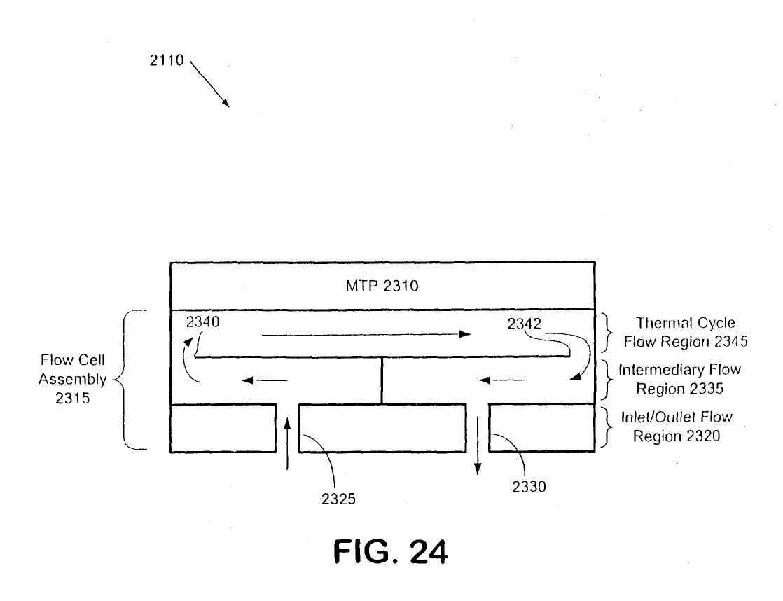

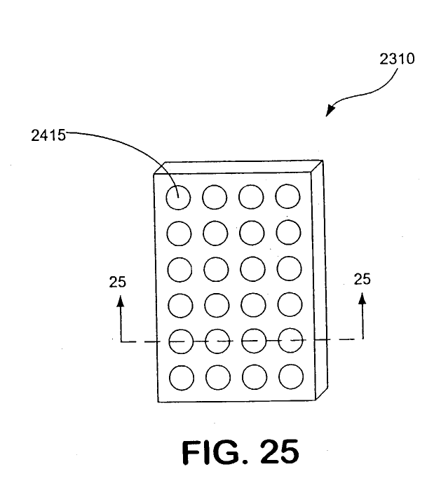

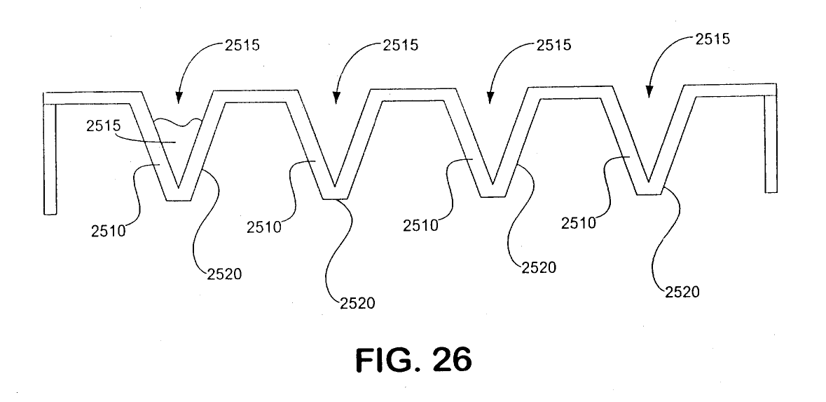

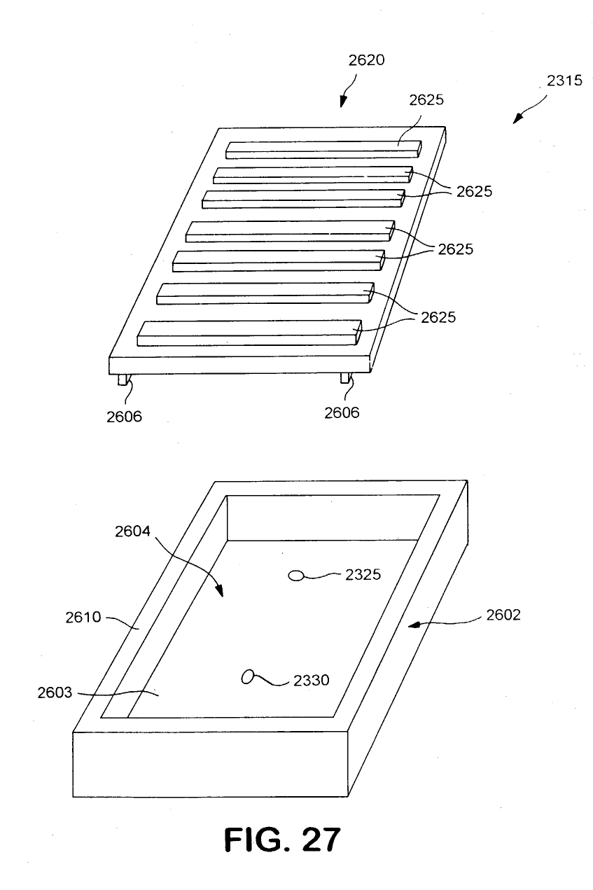

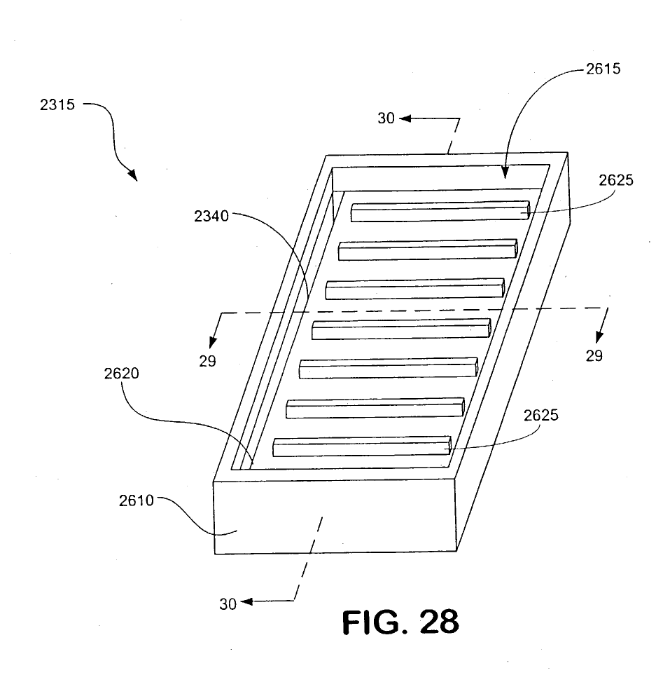

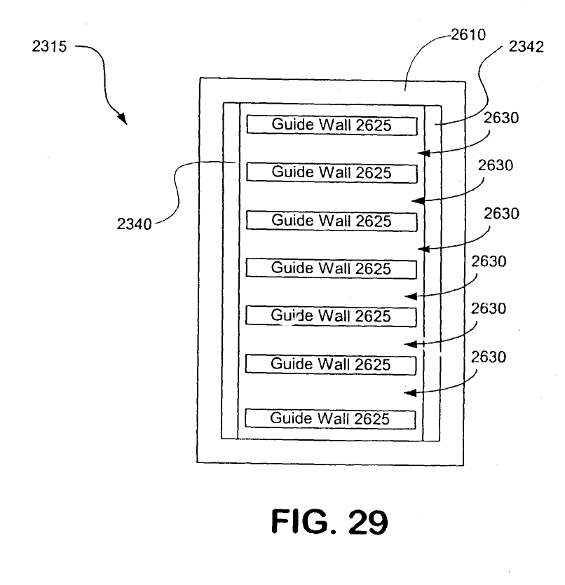

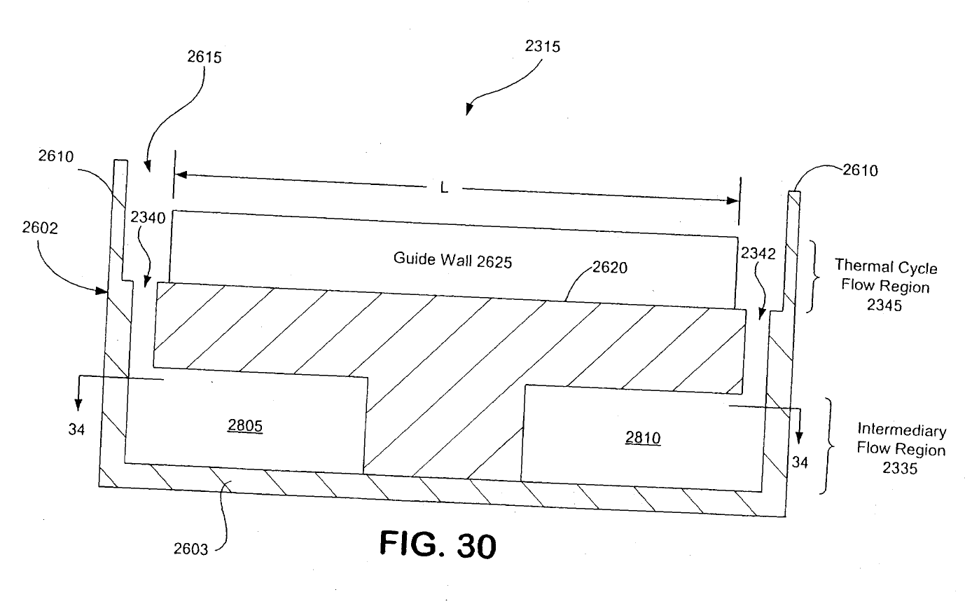

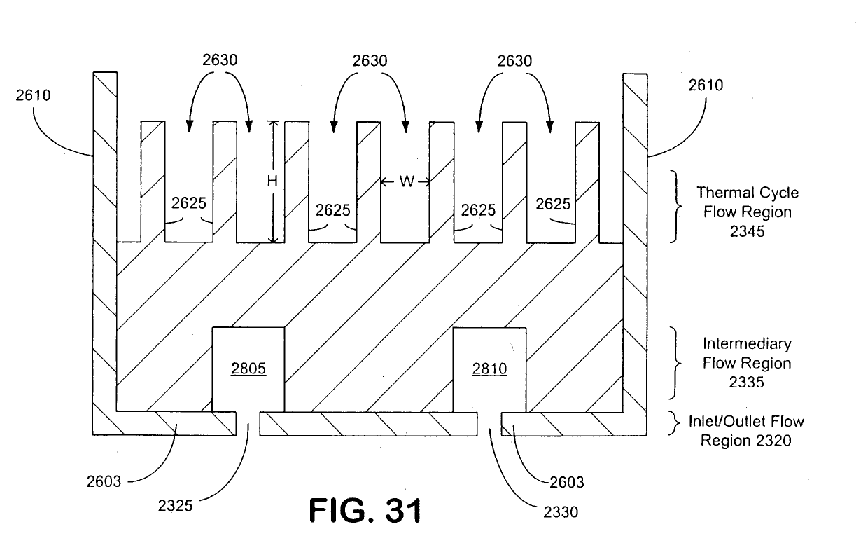

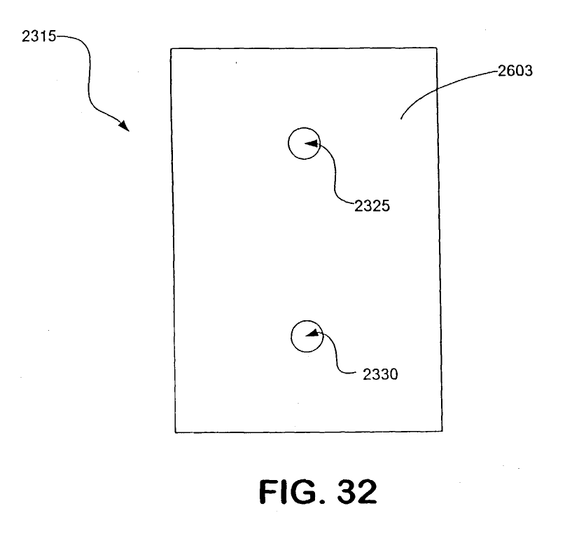

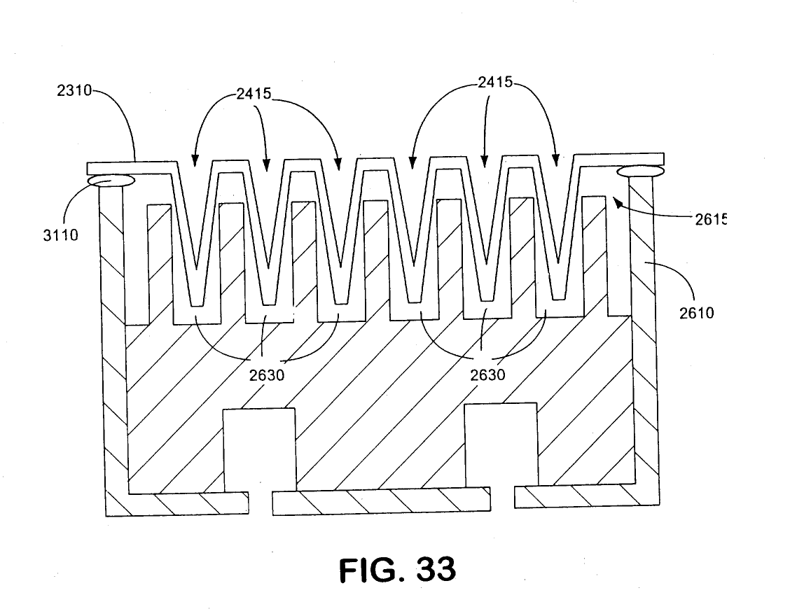

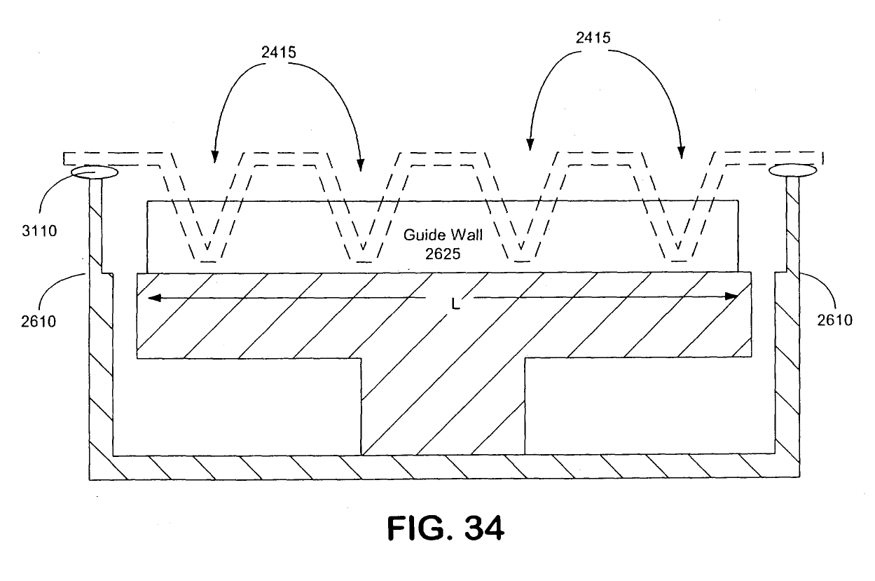

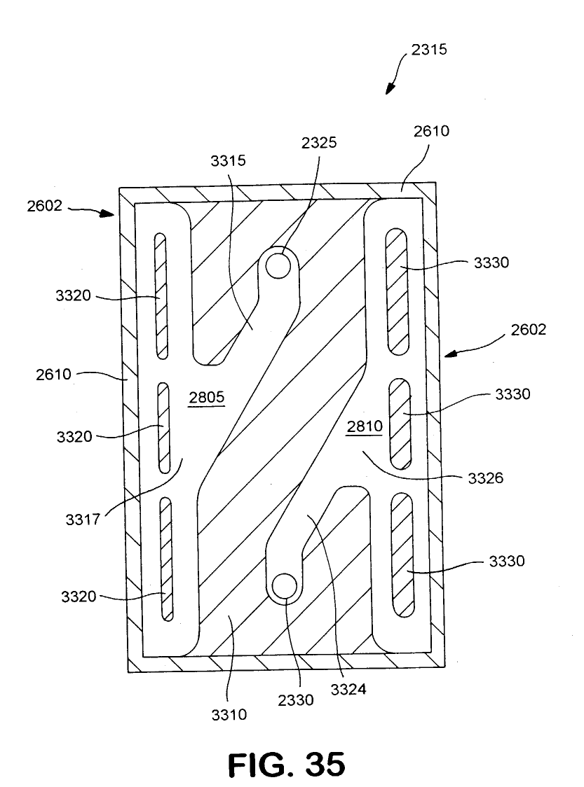

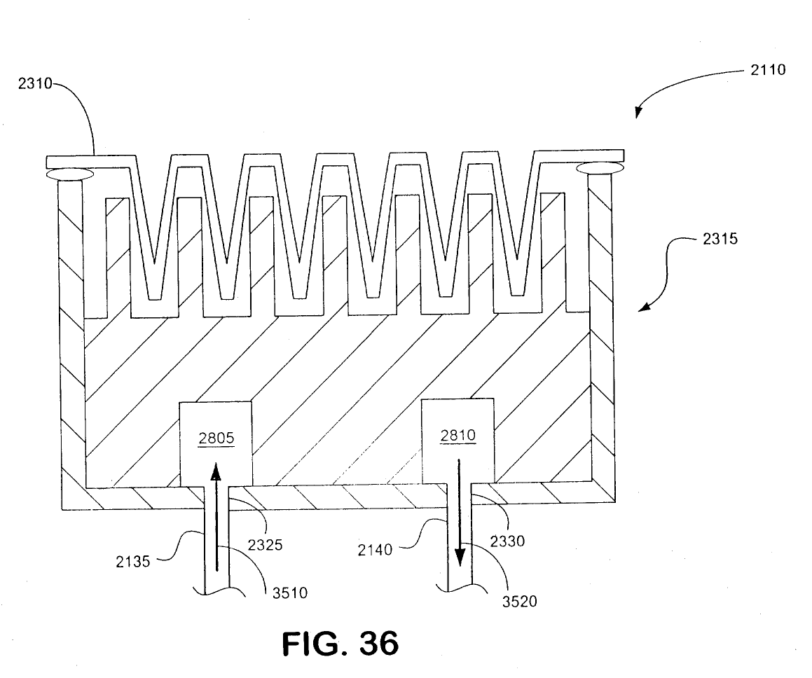

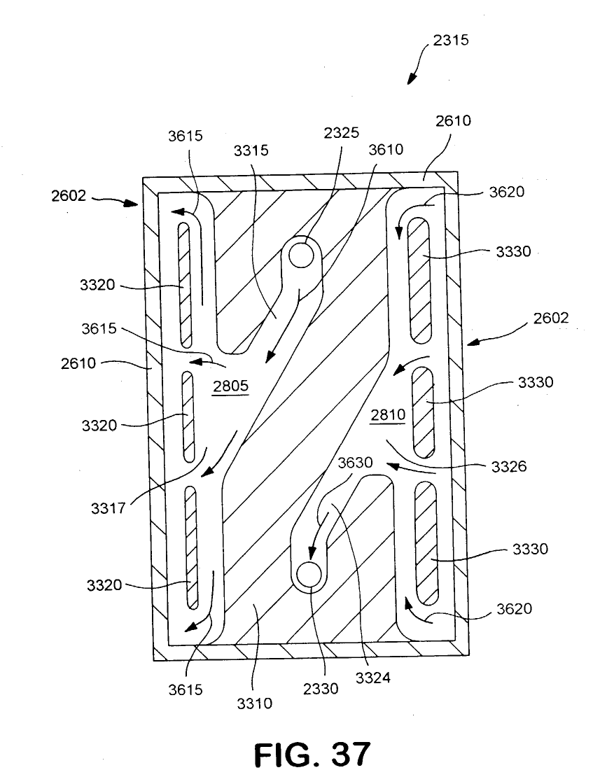

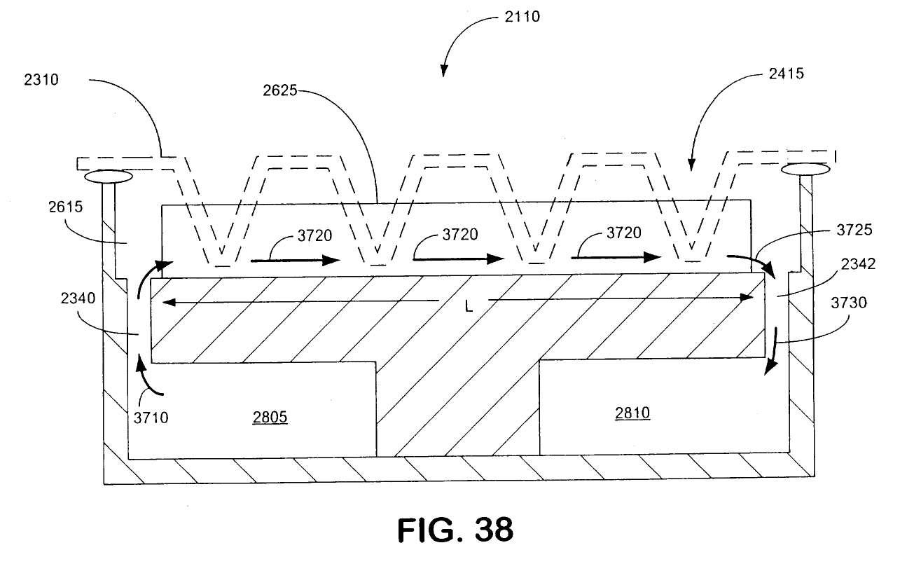

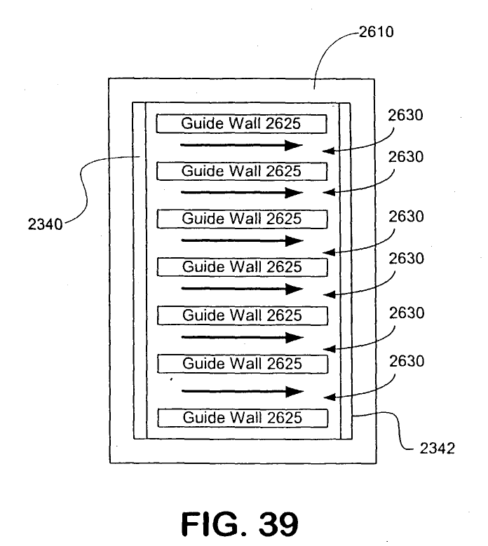

Referring to FIG. 2, an illustrative coated cartridge heating device 10 comprises an electrical resistance heating means such as a helical heating wire coil 12 disposed in an outer protective metallic sheath or housing 13. The resistance wire coil 12 is wound around a cylindrical electrical insulating, ceramic core 14 made, for example only, of compressed 96% magnesia. The resistance wire coil 12 is enclosed in a dielectric material 15 such as, for example only, fused magnesia powder particulates, within the housing 13 to provide electrical insulation between the coil and the housing. Housing 13 is closed at one end by an enlarged end of core 14 and at the other end by a metallic end cap 13b welded or otherwise attached thereon. The housing 13 typically is swaged after the heater components are assembled therein to reduce the diameter of the heating device and radially compress the housing 13 and dielectric material 15 about the core 14. For purposes of illustration and not limitation, the resistance wire coil 12 comprises a nickel chromium alloy wire, while the housing 13 and end cap 13b comprise an austenitic stainless steel such as, for example only, Type 321 stainless steel, or a nickel base alloy such as Incoloy 800 alloy. The wire coil is connected at regions R to electrical conductor pins 17, 18 which are connected to respective lead wires L1, L2. Lead wires L1, L2 are connected to a conventional electrical power source P via a conventional electrical connection box or controller C to pass electrical current through the resistance wire coil 12.

Another illustrative cartridge heating device to which the anti-binding coating 10a can be applied is described in copending Jeffrey V. Wheeler patent application Ser. No. 09/970,733 filed Oct. 4, 2001 which is allowed, the teachings of which are incorporated herein by reference.

The heating device 10 includes anti-binding or anti-seizing outer coating 10a on the exterior surface of the metallic sheath or housing 13. The coating 10a preferably includes a metallic matrix 17, FIG. 3A, having a non-metallic constituent 19 distributed as distinct regions (black regions in FIG. 3A) in the matrix. The metallic matrix is selected from a metal or alloy that resists binding with the surface 20b defining the passage 20a in metallic member 20 over time at elevated temperature. The non-metallic constituent 19 is selected from a polymer or other non-metallic material that imparts non-sticking and lubrication properties to the coating. The thickness of the coating 10a can be in the range of 0.0002 to 0.001 inch for purposes of illustration only as other coating thicknesses can be used.

For a metallic member 20 comprising steel, the metallic matrix preferably comprises nickel or an alloy based on nickel (i.e. having a majority of Ni in its composition). The constituent 19 preferably comprises distinct regions (black regions in FIG. 3A) of polytetrafluoroethylene (PTFE) distributed in the nickel matrix 17, FIG. 3A. For purposes of illustration and not limitation, anti-binding coating 10a can comprise a non-magnetic NICOTEF coating applied by Nimet Industries Inc., 2424 N Foundation Road, South Bend, Ind. This coating comprises an electroless nickel-phosphorous alloy matrix including about 10.5 to about 12% by weight P and balance essentially Ni having a eutectic melting point of 1620 degrees F. (880 degrees C.). Distinct regions of the PTFE constituent 19 are distributed in the Ni—P alloy matrix and are exposed at or penetrate the outer surface 10s of the coating 10a as shown in FIG. 3A. The P concentration of the matrix Ni—P alloy can be varied from about 2 to about 12% by weight P to suit particular service applications. The PTFE material is present in an amount from about 10 to about 30% by weight of the total coating weight. Also for purposes of illustration and not limitation, anti-binding coating 10a may also comprise a NYFLON 25 coating applied by Armoloy of Illinois Inc., 118 Simonds Ave., Dekalb, Ill.

The NICOTEF coating 10a is applied to a thickness of 0.2 to 1.0 mil (0.0002 to 0.001 inch). The coating is applied after the housing 13 is cleaned and degreased.

A NICOTEF coating 10a resists binding or seizing in a steel member 20 even when the temperature of the heating device 10 and thus steel member 20 is above the melting temperature (e.g. 230 degrees F.) of the PTFE constituent 19. Typical operating temperatures of the heating device 10 are from 100 to 1380 degrees F. For example, a cartridge heating device 10 coated with the NICOTEF coating 10a having a thickness of 0.001 inch was found not to bind in a passage 20a (clearance of 0.0008 inch between coating 10a and surface 20b) of a steel mold after 1000 hours of heater operation at 800 degrees F. The coated heating device 10 was easily manually removed from (pulled out of) passage 20a after such prolonged time at temperature. The coated heating element resisted binding in the steel member even though the operating temperature of the heating device and the steel member was above the melting range of the PTFE polymer constituent. The coating remained bonded to the heating device without powdering or flaking off of the sheath or housing 13 over time.

In another illustrative embodiment of the present invention, the anti-binding or seizing coating 10a comprises a metallic coating material 11 devoid of the regions of constituent 19 as shown in FIG. 3B. The metallic coating material 11 is selected from a metal or alloy that resists binding or seizing with the adjacent surface 20b defining the passage 20a in metallic member 20 over time at elevated temperature. For example, for a metallic member 20 comprising steel, the metallic material preferably comprises nickel or an alloy based on nickel (i.e. having a majority of Ni in its composition). For example, the metallic coating can comprise a Ni—P alloy as described above or other Ni based alloy, such as high phosphorous electroless nickel plating.

A metallic coating 10a or coating matrix 17 other than nickel or nickel alloy described above can be used in practice of the invention. For example, other metallic materials that can be used for the anti-binding coating 10a or metallic matrix 17 can include, but are not limited to, stainless steel, titanium, chromium and other oxidation resistant metals or alloys under the service conditions to be experienced by the heating device 10 and can be applied by plasma spray, powder flame spray, and other conventional coating processes.

Although the invention has been described with respect to certain illustrative embodiments, those skilled in the art will appreciate that the invention is not so limited and can be changed, adapted and the like within the scope of the following claims.

I claim:

1. An electrical heating device, comprising a metallic housing in which an electrical heating element resides and a coating on said housing wherein said coating comprises a metallic material.

2. The device of claim 1 wherein said coating comprises a metallic matrix having a non-metallic constituent distributed in the matrix.

3. The device of claim 2 wherein said coating comprises a metallic matrix having a non-metallic non-sticking constituent distributed in the matrix.

4. The device of claim 2 wherein said coating comprises a metallic matrix having polytetrafluoroethylene regions distributed in the matrix.

5. The device of claim 1 wherein said metallic material comprises nickel.

6. The device of claim 2 wherein said matrix comprises nickel.

7. The device of claim 6 wherein said matrix comprises an alloy of Ni and P wherein P is present from about 2 to about 12% by weight.

8. The device of claim 2 wherein said matrix is selected from the group consisting of nickel, stainless steel, titanium, and chromium.

9. The device of claim 1 which includes a metallic housing on which said coating is applied.

10. The device of claim 9 wherein said metallic housing comprises a cylindrical housing.

11. The device of claim 1 which is a cartridge heating device.

12. The device of claim 1 which is a coil heating device.

13. A method of heating a metallic member, comprising disposing an electrical heating device having a coating comprising a metallic material thereon adjacent said metallic member and passing electrical current through a heating element of said heating device to heat said metallic member wherein said coating resists binding or seizing between said heating device and said metallic member.

14. The method of claim 13 wherein said heating device is disposed in a passage in said metallic member and electrical current is passed through a heating element of said heating device to heat said metallic member wherein said coating resists binding or seizing of said heating device in said passage.

15. The method of claim 14 including pulling said heating device out of said passage for replacement or repair.

16. The method of claim 13 wherein said heating device is disposed about said metallic member and electrical current is passed through a heating element of said heating device to heat said metallic member wherein said coating resists binding or seizing between said heating device and said metallic member.

17. The method of claim 13 wherein said coating comprises a metallic matrix having a non-metallic constituent distributed in the matrix.

18. The method of claim 13 wherein said coating comprises a metallic matrix having a non-metallic non-sticking constituent distributed in the matrix.

19. The method of claim 13 wherein said metallic member is heated to a temperature above a melting range of said non-metallic constituent.

20. The method of claim 13 wherein said coating comprises a metallic matrix having polytetrafluoroethylene regions distributed in the matrix.

21. The method of claim 13 wherein said metallic material comprises nickel.

22. The method of claim 21 wherein said matrix comprises an alloy of Ni and P wherein P is present from about 2 to about 12% by weight.

23. The method of claim 21 wherein said matrix is selected from the group consisting of nickel, stainless steel, titanium, and chromium.

24. The method of claim 13 wherein said heating device comprises a cartridge heating device.

25. The method of claim 13 including pulling said heating device out of said passage for replacement or repair.

26. Combination of an electrical heating device disposed adjacent a metallic member to be heated, wherein said heating device comprises a metallic housing in which an electrical heating element resides and an outer coating on said housing wherein said coating comprises a metallic material that resists binding with said metallic member.
